(19) United States
(12) Patent Application Publication
(10) Pub. No.: US 2026/0117881 A1
(43) Pub. Date: Apr. 30, 2026

(54) MULTI-DIRECTIONAL VENT LIMITER

(71) Applicant: FAIRVIEW LTD., Oakville (CA)

(72) Inventor: Peter Conn, Oakville (CA)

(21) Appl. No.: 19/483,235

(22) PCT Filed: May 10, 2024
(86) PCT No.: PCT/CA2024/050641

§ 371 Date: Nov. 10, 2025

Related U.S. Application Data
(60) Provisional application No. 63/501,506, filed on May 11, 2023.

(51) Int. Cl. F16K 24/04

(52) U.S. Cl. CPC F16K 24/04

(57) ABSTRACT

A multi-directional vent limiter includes a vent body including a lower vent body and an upper vent body. The lower vent body defines an inner chamber and an inlet port in communication with the inner chamber, and the upper vent body defines a first vent hole and a second vent hole. The upper vent body is rotatably disposed on the lower vent body, such that the first vent hole and the second vent hole are in communication with the inner chamber. The multi-directional vent limiter further includes a plug configured to be selectively insertable into one of the first vent hole and the second vent hole so as to hermetically seal one of the first vent hole and the second vent hole and allow another of the first vent hole and the second vent hole open to vent.

### CROSS-REFERENCE TO RELATED APPLICATIONS

This application claims priority to the U.S. Provisional Ser. No. 63/501,506, filed May 11, 2023, the entire disclosure of which is hereby incorporated by reference.

### FIELD OF THE DISCLOSURE

This disclosure relates to pipe fittings and, more particularly, to a vent limiter for a gas regulator.

### BACKGROUND OF THE DISCLOSURE

Vent limiters are designed for use indoors and in spaces where limiting the amount of gas that may escape due to diaphragm failure is critical. The use of flow restrictors to limit and/or control gas flow is an established practice in the petrochemical industry.

When using a vent-limiting device with a gas regulator, it must be mounted in a horizontal upright position to ensure proper venting direction. However, properly orienting the vent-limiting device can be challenging depending on the orientation of the device it is mounted to, such as a gas regulator. As a result, there is a need for a multi-directional vent limiter that allows for adjustment of the ventilation direction.

### BRIEF SUMMARY OF THE DISCLOSURE

An embodiment of the present disclosure provides a multi-directional vent limiter. The multi-directional vent limiter may comprise a vent body. The vent body may comprise a lower vent body defining an inner chamber and an inlet port in communication with the inner chamber. The vent body may further comprise an upper vent body defining a first vent hole and a second vent hole. The upper vent body may be rotatably disposed on the lower vent body, such that the first vent hole and the second vent hole are in communication with the inner chamber. The multi-directional vent limiter may further comprise a plug configured to be selectively insertable into one of the first vent hole and the second vent hole so as to hermetically seal one of the first vent hole and the second vent hole and allow another of the first vent hole and the second vent hole open to vent.

In some embodiments, the lower vent body may further define a seat in communication with the inner chamber, and the upper vent body may be rotatably disposed in the seat.

In some embodiments, an inner surface of the seat may define an annular groove, and the vent body may further comprise a sealing ring disposed in the annular groove and configured to hermetically seal the upper vent body to the lower vent body.

In some embodiments, the upper vent body may further define a central chamber in communication with the first vent hole and the second vent hole and an opening in communication with the central chamber, and the inner chamber of the lower vent may be is in communication with the central chamber of the upper vent body via the opening.

In some embodiments, the upper vent body may further include a check valve in communication with the central chamber and one of the first vent hole and the second vent hole.

In some embodiments, a periphery of the upper vent body may be hexagonally-shaped, and the second vent hole may be defined in a planar face of the hexagonally-shaped upper vent body.

In some embodiments, the first vent hole may be axially arranged with the upper vent body.

In some embodiments, the second vent hole may be radially arranged with the upper vent body.

In some embodiments, the second vent hole may be arranged orthogonal to the first vent hole.

In some embodiments, a rotary alignment of at least one of the first vent hole and the second vent hole may be adjustable based on rotation of the upper vent body relative to the lower vent body.

In some embodiments, the plug may be configured to be selectively insertable into each of the first vent hole and the second vent hole in an interchangeable manner.

In some embodiments, the plug may comprise a sealing screw selectively screwed into one of the first vent hole and the second vent hole.

In some embodiments, the plug may include a sealing member configured to hermetically seal the plug selectively inserted into one of the first vent hole and the second vent hole.

Another embodiment of the present disclosure provides a system. The system may comprise a gas regulator defining an outlet port configured to ventilate a fluid. The system may further comprise a multi-directional vent limiter of any of the embodiments of the present disclosure. The multi-directional vent limiter may be removably connected to the gas regulator, such that the inlet port is in communication with the outlet port of the gas regulator to ventilate the fluid through one of the first vent hole and the second vent hole.

In some embodiments, the multi-directional vent limiter may be configured to change a ventilation direction of the fluid by rotation of the upper vent body relative to the lower vent body.

In some embodiments, the multi-directional vent limiter may be configured to block a ventilation direction with the plug selectively inserted into one of the first vent hole and the second vent hole.

In some embodiments, the lower vent body of the multi-direction vent limiter may include a threaded connecting portion configured to connect to the gas regulator.

In some embodiments, a periphery of the lower vent body may be hexagonally-shaped.

Another embodiment of the present disclosure provides a method. The method may comprise connecting a multi-directional vent limiter to a gas regulator configured to ventilate a fluid from an outlet port. The multi-directional vent limiter may comprise a vent body. The vent body may comprise a lower vent body defining an inner chamber and an inlet port in communication with the inner chamber. The vent body may further comprise an upper vent body defining a first vent hole and a second vent hole. The upper vent body may be rotatably disposed on the lower vent body, such that the first vent hole and the second vent hole are in communication with the inner chamber. The multi-directional vent limiter may further comprise a plug removably inserted into the first vent hole. The inlet port may be in communication with the outlet port of the gas regulator to ventilate a fluid through the second vent hole. The method may further comprise rotating the upper vent body relative to the lower vent body to change a ventilation direction of the fluid through the second vent hole.

In some embodiments, the method may further comprise removing the plug from the first vent hole. The method may further comprise inserting the plug into the second vent hole, such that the fluid is configured to ventilate through the first vent hole, and the plug is configured to block fluid ventilation through the second vent hole.

### DESCRIPTION OF THE DRAWINGS

For a fuller understanding of the nature and objects of the disclosure, reference should be made to the following detailed description taken in conjunction with the accompanying drawings, in which:

FIG. 1 is a cross-sectional view of a multi-directional vent limiter according to an embodiment of the present disclosure;

FIG. 2 is a perspective view of the multi-directional vent limiter of FIG. 1, in which a first vent hole is open and a plug is inserted into a second vent hole;

FIG. 3 is a perspective view of the multi-directional vent limiter of FIG. 2, in which the plug is inserted into the first vent hole and the second vent hole is open;

FIG. 4 is a top view of the multi-directional vent limiter of FIG. 1;

FIG. 5 is a side view of the multi-directional vent limiter of FIG. 1, in which an upper vent body is at a first rotary position relative to a lower vent body;

FIG. 6 is a side view of the multi-directional vent limiter of FIG. 5, in which the upper vent body is rotated to a second rotary position relative to the lower vent body;

FIG. 7 is a cross-sectional view of a system of the present disclosure, in which a multi-directional vent limiter is connected to a gas regulator; and

FIG. 8 is a flowchart of a method according to an embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

The present disclosure generally relates to a multi-directional vent-limiting device. The multi-directional vent-limiting device can be used in connection with a gas regulator to allow for ventilation regardless of the position that the gas regulator may be mounted in. This can be done by reorienting the directional vent-limiting device such that one or more vent hole(s) are oriented in an optimal direction.

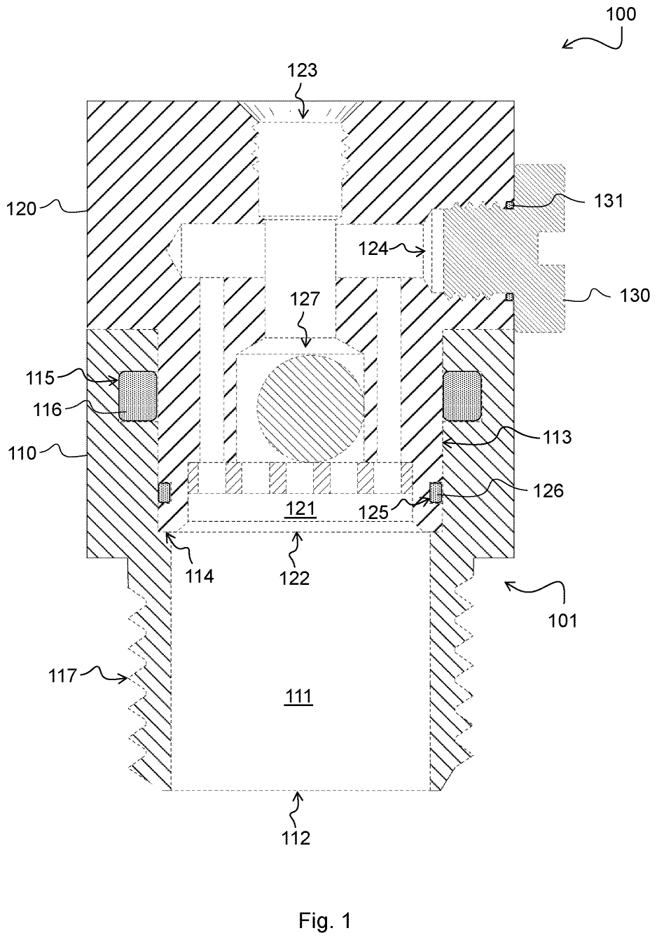

An embodiment of the present disclosure provides a multi-directional vent limiter 100, as shown in FIG. 1. The multi-directional vent limiter 100 may comprise a vent body 101. The vent body 101 may be generally hollow and configured to allow for a fluid (including, for example, a gas, liquid, or the like) to be ventilated through the vent body 101. The vent body 101 may comprise a lower vent body 110 and an upper vent body 120. As further described herein, the upper vent body 120 may be rotatable relative to the lower vent body 110 so as to change the direction through which the fluid is ventilated through the vent body 101.

The lower vent body 110 may define an inner chamber 111 and an inlet port 112 in communication with the inner chamber 111. In other words, the fluid may enter the vent body 101 via the inlet port 112 into the inner chamber 111 of the lower vent body. The lower vent body 110 may further define a seat 113 in communication with the inner chamber 111. In other words, the fluid in vent body 101 may travel from the inner chamber 111 through the seat 113. The inner chamber 111 may be substantially cylindrically shaped, and the seat 113 may be substantially cylindrically shaped. A diameter of the seat 113 may be greater than a diameter of the inner chamber 111, thereby forming an annular shoulder 114 in the lower vent body 110 at the transition between the inner chamber 111 and the seat 113.

The upper vent body 120 may define a central chamber 121 and an opening 122 in communication with the central chamber 121. The upper vent body 120 may be rotatably disposed on the lower vent body 110, such that the inner chamber 111 of the lower vent body 110 is in communication with the central chamber 121 of the upper vent body 120 via the opening 122. In other words, the fluid in the vent body 101 may travel from the inner chamber 111 into the central chamber 121. In some embodiments, the upper vent body 120 may be rotatably disposed in the seat 113 of the lower vent body 110. In some embodiments, the upper vent body 120 may be configured to rest on or abut against the annular shoulder 114 within the seat 113 of the lower vent body 110. The upper vent body 120 may further define a first vent hole 123 and a second vent hole 124 in communication with the central chamber 121. In other words, the fluid in the vent body 101 may travel from the central chamber 121 to the first vent hole 123 and the second vent hole 124 to ventilate the fluid through the vent body 101.

In some embodiments, an inner surface of the seat 113 of the lower vent body 110 may define a first annular groove 115. The first annular groove 115 may be axially arranged within the seat 113 between the annular shoulder 114 and an end of the lower vent body 110 opposite from the inlet 112. A first sealing ring 116 may be disposed in the first annular groove 115. For example, the first sealing ring 116 may be an elastomeric O-ring or the like. The first sealing ring 116 may be configured to hermetically seal the upper vent body 120 to the lower vent body 110, which may prevent leakage of fluid ventilating from the inner chamber 111 to the central chamber 221.

In some embodiments, an outer surface of the upper vent body 120 may define a second annular groove 125. The second annular groove 125 may be axially arranged along at portion of the upper vent body 120 that engages with the seat 113. A second sealing ring 126 may be disposed in the second annular groove 125. For example, the second sealing ring 126 may be an elastomeric O-ring or the like. The second sealing ring 126 may be configured to hermetically seal the upper vent body 120 to the lower vent body 110, which may prevent leakage of fluid ventilating from the inner chamber 111 to the central chamber 221.

In some embodiments, the vent body 101 may include device(s) for controlling the passage of the fluid therethrough. For example, the upper vent body 120 may further include a check valve 127, such as, for example, a ball valve, or a poppet valve, or the like. The check valve 127 may be in communication with the central chamber 121 and one of the first vent hole 123 or the second vent hole 124. In other words, the check valve 127 may be configured to control the passage of the fluid from the central chamber 121 through the respective one of the first vent hole 123 or the second cent hole 124.

The first vent hole 123 and the second vent hole 124 may be arranged to allow for different ventilation directions of the fluid from the vent body 101. For example, the first vent hole 123 and the second vent hole 124 may be arranged up to 180 degrees apart relative to a central axis of the vent body 101. In some embodiments, the second vent hole 124 may be orthogonal to the first vent hole 123, as shown in FIG. 1. The first vent hole 123 and the second vent hole 124 may be arranged along different axes of the vent body 101. For example, the first vent hole 123 may be axially arranged with the upper vent body 120 (e.g., coaxial with the central axis of the vent body 101). The second vent hole 124 may be radially arranged with the upper vent body 120 (e.g., along an axis that extends radially from the central axis of the vent body 101).

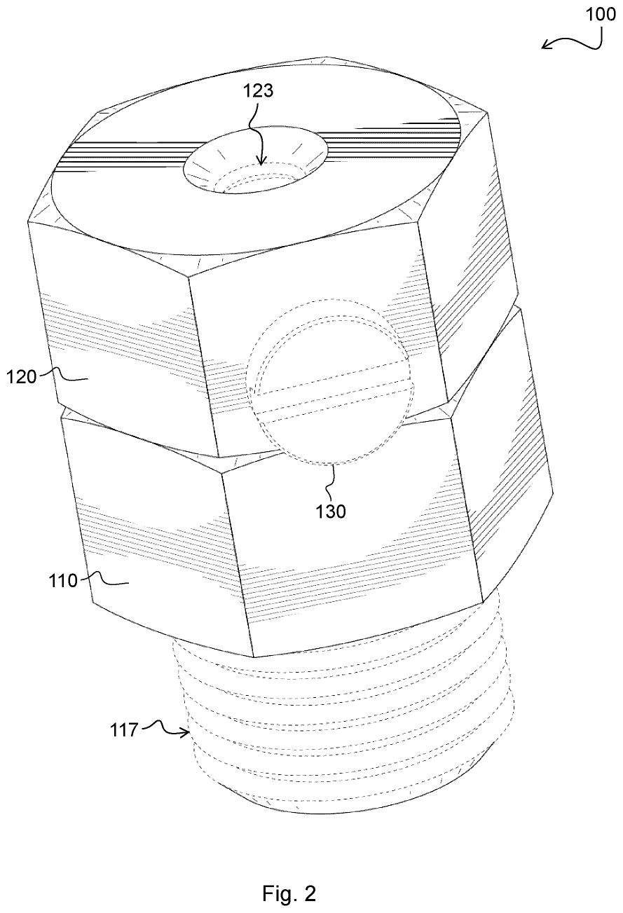

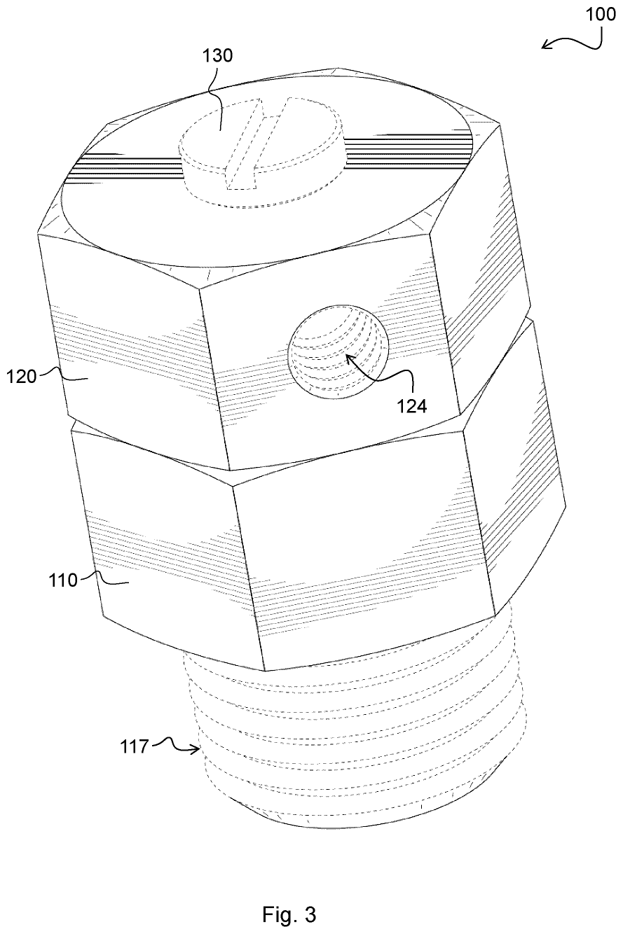

The multi-directional vent limiter 100 may further comprise a plug 130. The plug 130 may be selectively insertable into one of the first vent hole 123 and the second vent hole 124. The plug 130 may be configured to hermetically seal a vent hole or may be configured to reduce or limit fluid flow through a vent hole. The plug 130 may be configured to be partially or fully insertable in one of the first vent hole 123 and the second vent hole 124 and/or the plug 130 may be configured to be partially or fully removable in one of the first vent hole 123 and the second vent hole 124. In some embodiments, the plug 130 may be selectively insertable into each of the first vent hole 123 and the second vent hole 124 in an interchangeable manner. For example, FIG. 2 shows the plug 130 inserted into the second vent hole 124, and FIG. 3 shows the plug 130 inserted into the first vent hole 123. In other words, the dimensions of the first vent hole 123 and the second vent hole 124 may be substantially similar so as to receive the plug 130. In some embodiments, the dimensions of the first vent hole 123 and the second vent hole 124 may be different, such that the plug 130 may be removably inserted into only one of the first vent hole 123 or the second vent hole 124, and a different plug 130 may be removably inserted into the other one of the first vent hole 123 or the second vent hole 124. The plug 130 may include a sealing member 131. The sealing member 131 may be configured to hermetically seal the plug 130 inserted into one of the first vent hole 123 and the second vent hole 124. In other words, the sealing member 131 may be inserted into the first vent hole 123 or the second vent hole 124 or the sealing member 131 may cover the external surface of the upper vent body 120 over the first vent hole 123 or the second vent hole 124 when the plug 130 is inserted into the first vent hole 123 or the second vent hole 124. Accordingly, the plug 130 may be configured to block ventilation of the fluid through the first vent hole 123 or the second vent hole 124 when inserted into the respective one of the first vent hole 123 or the second vent hole 124 and may be used to select a direction of ventilation of the fluid from the vent body 101.

In some embodiments, the plug 130 may be a sealing screw that can be selectively screwed into one of the first vent hole 123 and the second vent hole 124 and selectively unscrewed to remove the sealing screw from the first vent hole 123 and the second vent hole 124. Alternatively, the plug 130 may be a press-fitted plug that can be selectively inserted into one of the first vent hole 123 and the second vent hole 124 and selectively removed from the first vent hole 123 and the second vent hole 124. The plug 130 may be another type of plug different from a sealing screw or a press-fitted plug and is not limited herein.

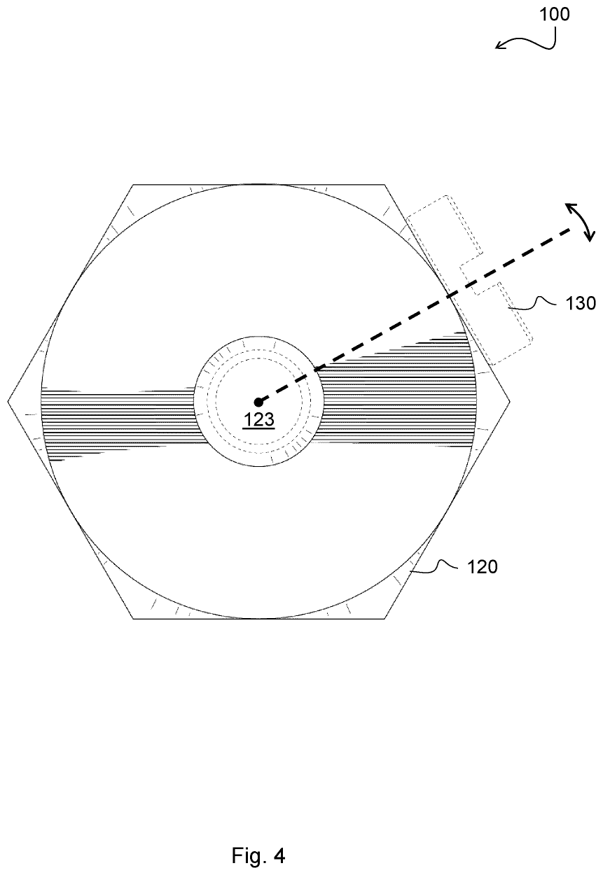

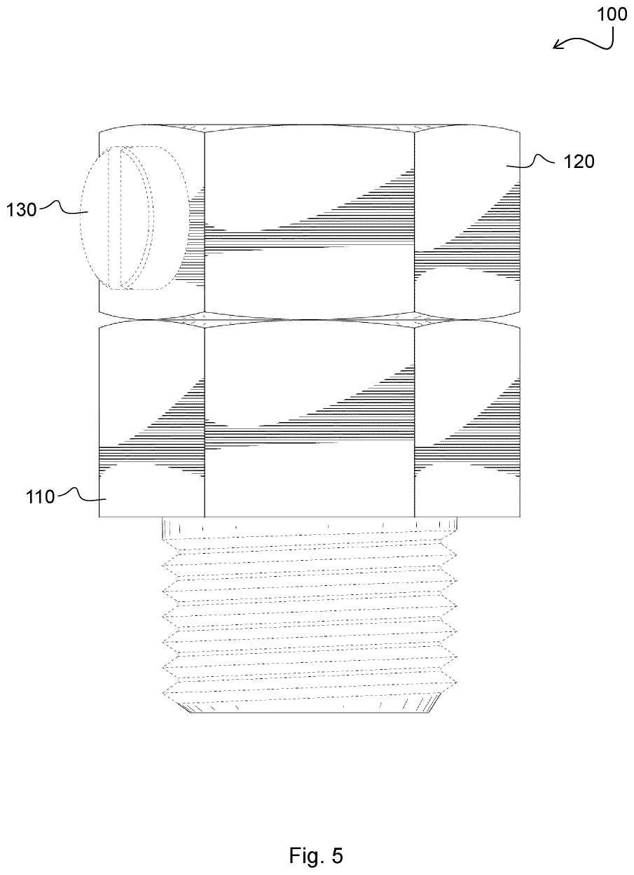

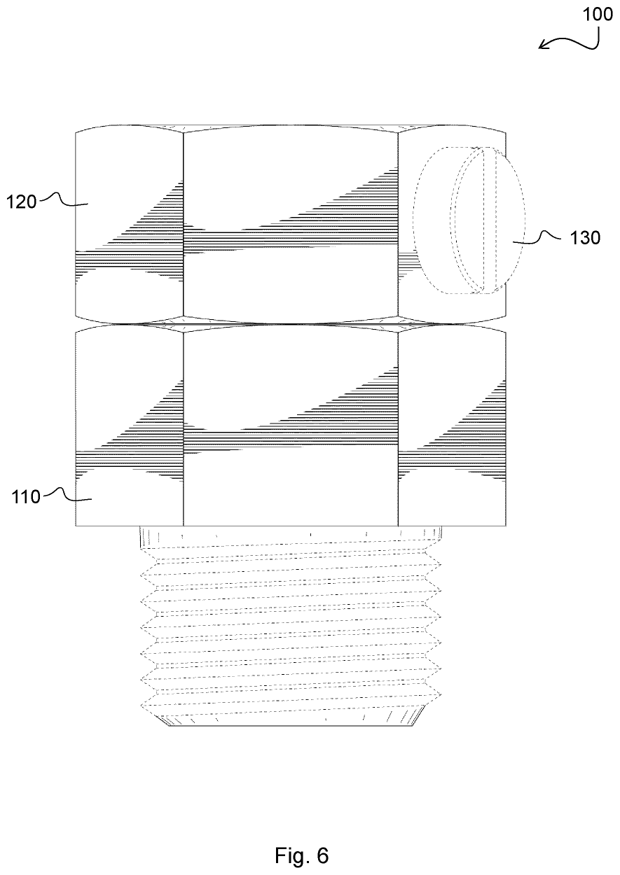

The upper vent body 120 may be rotatable relative to the lower vent body 110. For example, the upper vent body 120 may be configured to rotate along the central axis of the vent body 101 to adjust a rotary position of the upper vent body 120. As shown in FIG. 4, adjusting the rotary position of the upper vent body 120 may change the position of the second vent hole 124, which can change a ventilation direction of fluid. For example, the upper vent body 120 may be at a first rotary position (shown in FIG. 5) and can be rotated 120 degrees to a second rotary position (as shown in FIG. 6). The upper vent body 120 may be rotated any angle from 0 to 360 degrees and is not limited herein.

In some embodiments, the upper vent body 120 may be frictionally fit with the lower vent body 110, such that the upper vent body 120 will stay in a desired position relative to the lower vent body 110 unless its position is intentionally adjusted. For instance, the vent body 101 can be designed to provide enough friction between the upper vent body 120 and the lower vent body 110 to prevent unintended relative movement caused by external forces such as gravity, gas flow, vibration, etc. Although the illustrated embodiment shows the upper vent body 120 in direct contact with the lower vent body 110, it is possible to have intervening structures that achieve the same function and may provide a frictional fit between them.

The arrangement of the first vent hole 123 and the second vent hole 124 may depend on the peripheral shape of the upper vent body 120. In some embodiments, the upper vent body 120 may be hexagonally shaped. Accordingly, the rotational position of the upper vent body 120 relative to the lower vent body 110 may be adjusted manually with a wrench or the like. For example, the second vent hole 124 may be defined in a planar face of the hexagonally shaped upper vent body 120. The first vent hole 123 may be defined in an end face (i.e., orthogonal to the second vent hole 124) or a different planar face (i.e., 60 degrees, 120 degrees, or 180 degrees from the second vent hole 124) of the hexagonally shaped upper vent body 120. For an upper vent body 120 that has a different shape (e.g., round, square, octagonal, or other geometric, circular, or irregular shapes or the like), the arrangement of the first vent hole 123 and the second vent hole 124 may be at different angles relative to each other and is not limited herein.

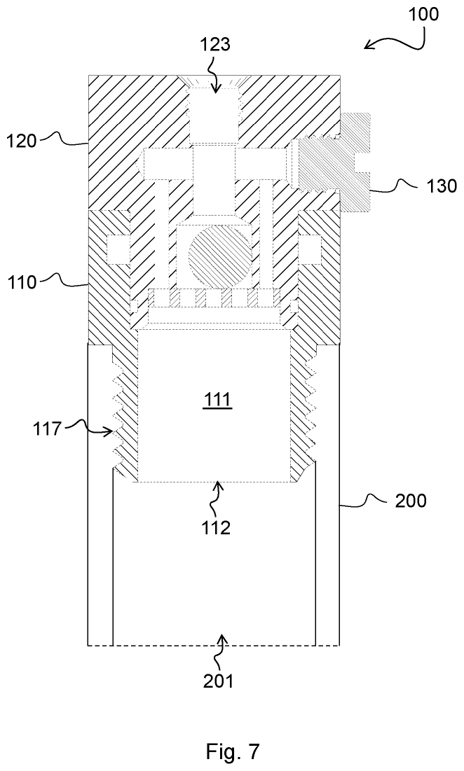

An embodiment of the present disclosure provides a system comprising the multi-directional vent limiter 100 and a gas regulator 200, as shown in FIG. 7. The multi-directional vent limiter 100 may be defined according to an of the embodiments described herein. The gas regulator 200 may define an outlet port 201 configured to ventilate a fluid. The multi-directional vent limiter 100 may be removably connected to the gas regulator 200, such that the inlet port 112 is in communication with the outlet port 201 to ventilate the fluid through the vent body 101 and through one of the first vent hole 123 and the second vent hole 124.

The lower vent body 110 may include a threaded connecting portion 117 configured to connect to the gas regulator 200. For example, the outlet port 201 of the gas regulator 200 may be a threaded opening configured to mate with the threaded connecting portion 117. In some embodiments, a periphery of the lower vent body may be hexagonally-shaped. Accordingly, the threaded connecting portion 117 of the lower vent body 110 can be connected to the gas regulator 200 manually with a wrench or the like. The lower vent body 110 may have other peripheral shapes (e.g., round, square, octagonal, or other geometric, circular, or irregular shapes or the like) and is not limited herein.

A ventilation direction of the fluid may depend on a rotary position of the upper vent body 120 relative to the lower vent body 110. For example, with the second vent hole 124 radially arranged with the upper vent body 120, a rotary alignment of the second vent hole 124 may change based on the rotational position of the upper vent body 120. Accordingly, a user can easily adjust the ventilation direction of the fluid in the field to meet a particular application by rotating the upper vent body 120.

A ventilation direction of the fluid may depend on the presence of the plug 130 in one of the first vent hole 123 or the second vent hole 124. For example, with the plug 130 inserted into the first vent hole 123, fluid ventilation is blocked from the first vent hole 123, such that the ventilation direction may be defined by the second vent hole 124. Alternatively, with the plug 130 inserted into the second vent hole 124, fluid ventilation is blocked from the second vent hole 124, such that the ventilation direction may be defined by the first vent hole 123. Accordingly, a user can easily adjust the rotation direction of the fluid in the field to meet a particular application by removing or inserting the plug 130 into one of the first vent hole 123 and the second vent hole 124.

In some embodiments, the multi-directional vent limiter 100 may include a plug 130 inserted into each of the first vent hole 123 and the second vent hole 124. Accordingly, a user can easily adjust the ventilation direction of the fluid in the field to meet a particular application by selectively removing one plug 130 and retaining the other plug 130 in one of the first vent hole 123 or the second vent hole 124.

In some embodiments, the multi-directional vent limiter 100 may include one or more vent holes in addition to the first vent hole 123 and the second vent hole 124, which can provide further options for controlling the ventilation direction by rotation of the upper vent body 120 relative to the lower vent body 110 and/or inserting one or more additional plugs into the additional vent holes.

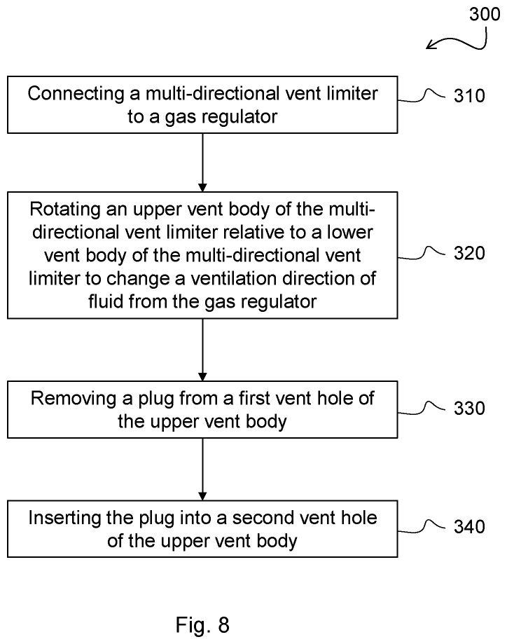

Another embodiment of the present disclosure provides a method 300. As shown in FIG. 8, the method 300 may comprise the following steps, the order of which is not limited herein.

At step 310, a multi-directional vent limiter is connected to a gas regulator. The multi-directional vent limiter may be the multi-directional vent limiter 100 described herein, and the gas regulator may be the gas regulator 200 described herein. For example, the plug 130 may be removable inserted into the first vent hole 123 of the upper vent body 120 described above.

At step 320, the upper vent body is rotated relative to the lower vent body to change a ventilation direction of the fluid through the second vent hole. For example, the second vent hole may be radially arranged, such that by changing the rotary position of the upper vent body, the ventilation direction of the fluid through the second vent hole also changes.

In some embodiments, step 320 may be performed after step 310. In other words, the multi-directional vent limiter is first connected to the gas regulator, and then the ventilation direction of the fluid is adjusted by rotating the upper vent body. Alternatively, step 320 may be performed before step 310. In other words, the upper vent body may be rotated to a desired ventilation direction before connecting the multi-directional vent limiter to the gas regulator.

The method 300 may further comprise steps 330 and 340. At step 330, the plug is removed from the first vent hole. At step 340, the plug is inserted into the second vent hole. In some embodiments, the plug may be fully or partially removed from the first vent hole at step 330, and the plug may be fully or partially inserted into the second vent hole at step 340. Accordingly, the fluid may be configured to ventilate through the first vent hole, and the plug is configured to block fluid ventilation through the second vent hole, thereby changing the ventilation direction of the fluid.

In some embodiments, steps 330 and 340 may be performed after step 310. In other words, the multi-directional vent limiter is first connected to the gas regulator, and then the placement of the plug is switched from the first vent hole to the second vent hole. Alternatively, steps 330 and 340 may be performed before step 310. In other words, the plug may be inserted into a desired one of the first vent hole or the second vent hole before connecting the multi-directional vent limiter to the gas regulator.

The following Statements describe various embodiments of the present disclosure:

Statement 1. A multi-directional vent limiter comprising: a vent body comprising: a lower vent body defining an inner chamber and an inlet port in communication with the inner chamber; and an upper vent body defining a first vent hole and a second vent hole, wherein the upper vent body is rotatably disposed on the lower vent body, such that the first vent hole and the second vent hole are in communication with the inner chamber; and a plug configured to be selectively insertable into one of the first vent hole and the second vent hole so as to hermetically seal one of the first vent hole and the second vent hole and allow another of the first vent hole and the second vent hole open to vent.

Statement 2. A multi-directional vent limiter of Statement 1, wherein the lower vent body further defines a seat in communication with the inner chamber, and the upper vent body is rotatably disposed in the seat.

Statement 3. A multi-directional vent limiter of any one of the preceding Statements, wherein an inner surface of the seat defines an annular groove, and the vent body further comprises a sealing ring disposed in the annular groove and configured to hermetically seal the upper vent body to the lower vent body.

Statement 4. A multi-directional vent limiter of any one of the preceding Statements, wherein the upper vent body further defines a central chamber in communication with the first vent hole and the second vent hole and an opening in communication with the central chamber, and the inner chamber of the lower vent body is in communication with the central chamber of the upper vent body via the opening.

Statement 5. A multi-directional vent limiter of any one of the preceding Statements, wherein the upper vent body further includes a check valve in communication with the central chamber and one of the first vent hole and the second vent hole.

Statement 6. A multi-directional vent limiter of any one of the preceding Statements, wherein a periphery of the upper vent body is hexagonally-shaped, and the second vent hole is defined in a planar face of the hexagonally-shaped upper vent body.

Statement 7. A multi-directional vent limiter of any one of the preceding Statements, wherein the first vent hole is axially arranged with the upper vent body.

Statement 8. A multi-directional vent limiter of any one of the preceding Statements, wherein the second vent hole is radially arranged with the upper vent body.

Statement 9. A multi-directional vent limiter of any one of the preceding Statements, wherein the second vent hole is arranged orthogonal to the first vent hole.

Statement 10. A multi-directional vent limiter of any one of the preceding Statements, wherein a rotary alignment of at least one of the first vent hole and the second vent hole is adjustable based on rotation of the upper vent body relative to the lower vent body.

Statement 11. A multi-directional vent limiter of any one of the preceding Statements, wherein the plug is configured to be selectively insertable into each of the first vent hole and the second vent hole in an interchangeable manner.

Statement 12. A multi-directional vent limiter of any one of the preceding Statements, wherein the plug comprises a sealing screw selectively screwed into one of the first vent hole and the second vent hole.

Statement 13. A multi-directional vent limiter of any one of the preceding Statements, wherein the plug includes a sealing member configured to hermetically seal the plug selectively inserted into one of the first vent hole and the second vent hole.

Statement 14. A system comprising: a gas regulator defining an outlet port configured to ventilate a fluid; and the multi-directional vent limiter of any one of the preceding Statements; wherein the multi-directional vent limiter is removably connected to the gas regulator, such that the inlet port is in communication with the outlet port of the gas regulator to ventilate the fluid through one of the first vent hole and the second vent hole.

Statement 15. A system of Statement 14, wherein the multi-directional vent limiter is configured to change a ventilation direction of the fluid by rotation of the upper vent body relative to the lower vent body.

Statement 16. A system of Statement 14 or 15, wherein the multi-directional vent limiter is configured to block a ventilation direction with the plug selectively inserted into one of the first vent hole and the second vent hole.

Statement 17. A system of any one of Statements 14 to 16, wherein the lower vent body of the multi-direction vent limiter includes a threaded connecting portion configured to connect to the gas regulator.

Statement 18. A system of any one of Statements 14 to 17, wherein a periphery of the lower vent body is hexagonally-shaped.

Statement 19. A method comprising: connecting a multi-directional vent limiter to a gas regulator configured to ventilate a fluid from an outlet port, wherein the multi-directional vent limiter comprises: a vent body comprising: a lower vent body defining an inner chamber and an inlet port in communication with the inner chamber; and an upper vent body defining a first vent hole and a second vent hole, wherein the upper vent body is rotatably disposed on the lower vent body, such that the first vent hole and the second vent hole are in communication with the inner chamber; and a plug removably inserted into the first vent hole, wherein the inlet port is in communication with the outlet port of the gas regulator to ventilate a fluid through the second vent hole; and rotating the upper vent body relative to the lower vent body to change a ventilation direction of the fluid through the second vent hole.

Statement 20. A method of Statement 19, further comprising: removing the plug from the first vent hole; and inserting the plug into the second vent hole, such that the fluid is configured to ventilate through the first vent hole, and the plug is configured to block fluid ventilation through the second vent hole.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A multi-directional vent limiter comprising:
a vent body comprising:
a lower vent body defining an inner chamber and an inlet port in communication with the inner chamber; and
an upper vent body defining a first vent hole and a second vent hole, wherein the upper vent body is rotatably disposed on the lower vent body, such that the first vent hole and the second vent hole are in communication with the inner chamber; and
a plug configured to be selectively insertable into one of the first vent hole and the second vent hole so as to hermetically seal one of the first vent hole and the second vent hole and allow another of the first vent hole and the second vent hole open to vent.

2. The multi-directional vent limiter of claim 1, wherein the lower vent body further defines a seat in communication with the inner chamber, and the upper vent body is rotatably disposed in the seat.

3. The multi-directional vent limiter of claim 2, wherein an inner surface of the seat defines an annular groove, and the vent body further comprises a sealing ring disposed in the annular groove and configured to hermetically seal the upper vent body to the lower vent body.

4. The multi-directional vent limiter of claim 2, wherein the upper vent body further defines a central chamber in communication with the first vent hole and the second vent hole and an opening in communication with the central chamber, and the inner chamber of the lower vent body is in communication with the central chamber of the upper vent body via the opening.

5. The multi-directional vent limiter of claim 4, wherein the upper vent body further includes a check valve in communication with the central chamber and one of the first vent hole and the second vent hole.

6. The multi-directional vent limiter of claim 1, wherein a periphery of the upper vent body is hexagonally-shaped, and the second vent hole is defined in a planar face of the hexagonally-shaped upper vent body.

7. The multi-directional vent limiter of claim 1, wherein the first vent hole is axially arranged with the upper vent body.

8. The multi-directional vent limiter of claim 1, wherein the second vent hole is radially arranged with the upper vent body.

9. The multi-directional vent limiter of claim 1, wherein the second vent hole is arranged orthogonal to the first vent hole.

10. The multi-directional vent limiter of claim 1, wherein a rotary alignment of at least one of the first vent hole and the second vent hole is adjustable based on rotation of the upper vent body relative to the lower vent body.

11. The multi-directional vent limiter of claim 1, wherein the plug is configured to be selectively insertable into each of the first vent hole and the second vent hole in an interchangeable manner.

12. The multi-directional vent limiter of claim 1, wherein the plug comprises a sealing screw selectively screwed into one of the first vent hole and the second vent hole.

13. The multi-directional vent limiter of claim 1, wherein the plug includes a sealing member configured to hermetically seal the plug selectively inserted into one of the first vent hole and the second vent hole.

14. A system comprising:
a gas regulator defining an outlet port configured to ventilate a fluid; and
the multi-directional vent limiter of claim 1;
wherein the multi-directional vent limiter is removably connected to the gas regulator, such that the inlet port is in communication with the outlet port of the gas regulator to ventilate the fluid through one of the first vent hole and the second vent hole.

15. The system of claim 14, wherein the multi-directional vent limiter is configured to change a ventilation direction of the fluid by rotation of the upper vent body relative to the lower vent body.

16. The system of claim 14, wherein the multi-directional vent limiter is configured to block a ventilation direction with the plug selectively inserted into one of the first vent hole and the second vent hole.

17. The system of claim 14, wherein the lower vent body of the multi-direction vent limiter includes a threaded connecting portion configured to connect to the gas regulator.

18. The system of claim 17, wherein a periphery of the lower vent body is hexagonally-shaped.

19. A method comprising:
connecting a multi-directional vent limiter to a gas regulator configured to ventilate a fluid from an outlet port, wherein the multi-directional vent limiter comprises:
a vent body comprising:
a lower vent body defining an inner chamber and an inlet port in communication with the inner chamber; and
an upper vent body defining a first vent hole and a second vent hole, wherein the upper vent body is rotatably disposed on the lower vent body, such that the first vent hole and the second vent hole are in communication with the inner chamber; and
a plug removably inserted into the first vent hole, wherein the inlet port is in communication with the outlet port of the gas regulator to ventilate a fluid through the second vent hole; and
rotating the upper vent body relative to the lower vent body to change a ventilation direction of the fluid through the second vent hole.

20. The method of claim 19, further comprising:
removing the plug from the first vent hole; and
inserting the plug into the second vent hole, such that the fluid is configured to ventilate through the first vent hole, and the plug is configured to block fluid ventilation through the second vent hole.
